(19) United States
(12) Patent Application Publication
(10) Pub. No.: US 2017/0017978 A1
(43) Pub. Date: Jan. 19, 2017

(54) COMPUTER PLATFORM FOR MANAGING THIRD PARTY INTERACTIONS AND GENERATING ANALYTICS THEREFORE

(71) Applicant: Andrew G. WALLACE, River Edge, NJ (US)

(72) Inventor: Andrew G. WALLACE, River Edge, NJ (US)

(21) Appl. No.: 15/207,954

(22) Filed: Jul. 12, 2016

Related U.S. Application Data
(60) Provisional application No. 62/191,678, filed on Jul. 13, 2015.

(51) Int. Cl. G06Q 30/02; G06Q 30/06

(52) U.S. Cl. CPC G06Q 30/0207; G06Q 30/0613

(57) ABSTRACT

A system, non-transitory computer readable medium, and method for managing third party interactions. The method includes identifying at least one transaction, wherein each transaction is between a first device and one of a plurality of second devices; obtaining transaction data of each identified transaction; identifying at least one redemption, wherein each redemption is between the first device and one of a plurality of third devices; obtaining redemption data of each identified redemption; determining, based on the transaction data and the redemption data, a total point value associated with the first device; and generating a computer readable token for the first device, the token including each transaction identifier and each redemption identifier, the token further including metadata, wherein the metadata includes the determined total point value.

### CROSS-REFERENCE TO RELATED APPLICATIONS

This application claims the benefit of U.S. Provisional Patent Application No. 62/191,678 filed on Jul. 13, 2015, the contents of which are hereby incorporated by reference for all that they contain.

### TECHNICAL FIELD

The disclosure generally relates to a platform for managing third party interactions, and more particularly to a platform for managing redemptions of rewards via third parties.

### BACKGROUND

Every year, many non-profit organizations struggle to obtain adequate funding to continue operating. These organizations find themselves spending large amounts of time on grant writing rather than performing their established purpose. There are roughly 1.5 million non-profit organizations in the United States alone. These organizations often compete with one another for funding. As a result, non-profit organizations have turned to alternative solutions to obtain funding, typically in the form of donations. Such solutions are typically primarily CRM-focused and offer software solutions via expensive licensing.

Current alternative solutions offer non-profit organizations a portion of existing commercial transactions. Search engines such as GoodSearch® distribute a minimal sum to a non-profit organization of a user's choice for each search the user conducts. E-commerce websites such as Amazon® enable purchasers to select a non-profit organization to receive a small percentage of the sale price of goods. However, none of these solutions foster direct donations of time, money, or materials.

For-profit business vendors continually seek out new ways to advertise and draw in new customers. Business vendors pay large fees for advertising in traditional methods, such as newspaper advertisements, billboards, mailers, commercials, and the like. Modern advertising solutions such as Groupon® and Living Social® create deals to entice new customers, but retain as much as 50% of the received revenue.

Business vendors are also seeing an increasing need to appear socially responsible. Large vendors spend increasingly larger budgets on corporate sponsorship and public relations. Smaller vendors are becoming more active in their communities to be seen as community participants, which can be strenuous upon start-ups and “mom and pop” shops with few resources.

Potential donors are primarily concerned with how to best spend their money, time, and materials. Donors want as much of their donation to directly contribute to a non-profit organization's operations as possible. Additionally, donors may be enticed to donate more time, money, and materials if the donor receives rewards in return. Currently, the main incentive for a donor to donate, besides altruism, is a tax deduction.

Some existing solutions provide a platform for donors to directly fund specific projects conducted by social entrepreneurs and non-profit organizations. However, these solutions are limited to fiscal donations and only provide pre-existing tax deductions to donors. Additionally, non-profit organizations are not provided with many tools, if any, to differentiate themselves through location-based recommendations, social network integration, and the like.

Additionally, some companies utilize point or other transaction-based incentives to motivate users to engage in more transactions. For example, credit card and airline companies often offer points based on purchases which may be redeemed for rewards. Such incentives typically include offering rewards directly through the rewarding company or through a designated third party rewards entity, often only at particular physical (e.g., geographic) or network (e.g., web address) locations. Accordingly, many incentive-based programs face challenges in flexibly adapting to changes in third party incentive providers.

Therefore, it would be advantageous to provide a solution that overcomes the disadvantages of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The embodiments disclosed herein include a method for managing third party interactions. The method comprises: identifying at least one transaction, wherein each transaction is between a first device and one of a plurality of second devices; obtaining transaction data of each identified transaction; identifying at least one redemption, wherein each redemption is between the first device and one of a plurality of third devices; obtaining redemption data of each identified redemption; determining, based on the transaction data and the redemption data, a total point value associated with the first device; and generating a computer readable token for the first device, the token including each transaction identifier and each redemption identifier, the token further including metadata, wherein the metadata includes the determined total point value.

The embodiments disclosed herein also include a non-transitory computer readable medium for managing third party interactions. The non-transitory computer readable medium has stored thereon instructions for causing one or more processing units to: identify at least one transaction, wherein each transaction is between a first device and one of a plurality of second devices; obtain transaction data of each identified transaction, wherein the transaction data includes a value and a transaction identifier of each transaction; identify at least one redemption, wherein each redemption is between the first device and one of a plurality of third devices; obtain redemption data of each identified redemption, wherein the redemption data includes a point value deduction and a redemption identifier associated with each redemption; determine, based on the transaction data and the redemption data, a total point value associated with the first device; and generate a computer readable token for the first device, the token including each transaction identifier and each redemption identifier, the token further including metadata, wherein the metadata includes the determined total point value.

The embodiments disclosed herein also include a system for managing third party interactions. The system comprises: a processing unit; and a memory, the memory containing instructions that, when executed by the processing unit, configure the system to: identify at least one transaction, wherein each transaction is between a first device and one of a plurality of second devices; obtain transaction data of each identified transaction, wherein the transaction data includes a value and a transaction identifier of each transaction; identify at least one redemption, wherein each redemption is between the first device and one of a plurality of third devices; obtain redemption data of each identified redemption, wherein the redemption data includes a point value deduction and a redemption identifier associated with each redemption; determine, based on the transaction data and the redemption data, a total point value associated with the first device; and generate, by the token generator, the token for the first device, the token including each transaction identifier and each redemption identifier, the token further including metadata, wherein the metadata includes the determined total point value.

### BRIEF DESCRIPTION OF THE DRAWINGS

The foregoing and other objects, features, and advantages of the disclosed embodiments will be apparent from the following detailed description taken in conjunction with the accompanying drawings.

FIG. 1 is a network diagram utilized to describe the disclosed embodiments.

FIG. 2 is a flowchart illustrating a method for managing third party interactions according to an embodiment.

FIG. 3 is a flowchart illustrating a method for redeeming points according to an embodiment.

FIG. 4 is a flowchart illustrating a method for classifying tokens according to an embodiment.

FIG. 5 is a flowchart illustrating a method for generating analytics based on third party interactions according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various example embodiments disclosed herein include a platform for managing third party interactions. The platform assigns points to users based on transactions. The points may be redeemed from participating rewards entities. For each user, a token is generated and updated based on monitoring of transactions and redemptions. Based on the tokens, analytics related to transactions and redemptions may be generated.

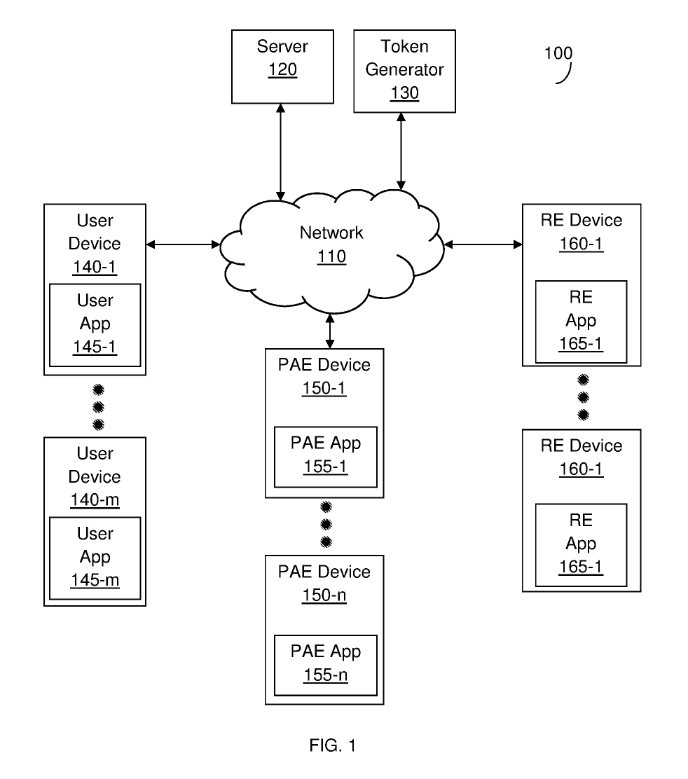

FIG. 1 is an example network diagram 100 utilized to describe the various disclosed embodiments. A network 110 is used to communicate between different parts of the network system 100. The network 110 may be the Internet, the world-wide-web (WWW), a local area network (LAN), a wide area network (WAN), a metro area network (MAN), and the like.

In the example network diagram 100, the network 110 is communicatively connected to a server 120, a token generator 130, a plurality of user devices 140-1 through 140-m (hereinafter referred to individually as a user device 140 and collectively as user devices 140, merely for simplicity purposes), a plurality of point assigning entity (PAE) devices 150 (hereinafter referred to individually as a PAE device 150 and collectively as PAE devices 150, merely for simplicity purposes), and a plurality of rewards entity (RE) devices 160 (hereinafter referred to individually as a rewards entity device 160 and collectively as rewards entity devices 160, merely for simplicity purposes).

In an example, the user devices 140 may be associated with donors; the PAE devices 150 may be associated with organizations such as non-profit, not-for-profit, or otherwise charitable organizations; and the rewards entity devices 160 may be associated with providers of rewards. In another example, the user devices 140 may be associated with customers; the PAE devices 150 may be associated with business organizations selling goods, services, or credit (e.g., an airline or credit card company); and the rewards entity devices 160 may be associated with providers of rewards.

The server 120 is configured to identify transactions and redemptions involving users of the user devices 140. The transactions may include, but are not limited to, charitable transactions (i.e., donations) or commercial transactions (i.e., purchases). The donations or purchases may include, but are not limited to, transfers of currency, transfers of goods, provision of services (e.g., based on time spent working on a particular endeavor), combinations thereof, and the like. The redemptions may include granting access to rewards such as, but are not limited to, transfers of currency, transfers of goods, provision of services, provision of access to limited or otherwise exclusive offers, combinations thereof, and the like. In an embodiment, the server 120 may be further configured to allow transfer (i.e., gifts) of points among or otherwise to users of the user devices 140. In a further embodiment, the transactions may include such transfers of points to a recipient (e.g., a user of one of the user devices 140).

Based on the identified transactions and redemptions, the server 120 is configured to assign points or to deduct from assigned points to users of the user devices 140. The server 120 may be configured to assign points when a transaction is claimed, i.e., when a user transfers currency or goods, or performs services. The server 120 may be configured to deduct points when a redemption is claimed, i.e., when a user chooses to redeem points and obtain access to a reward.

The server 120 may be configured to assign points only for particular point-eligible transactions (e.g., transactions selected by rewards entities using the rewards entity devices 160). The point-eligible transactions may further be limited in number (e.g., only the first 10 transactions may be eligible for assigning points). The server 120 may be further configured to process the transactions and redemptions (e.g., the server 120 may receive input related to purchases or donations and may, if appropriate, prompt fulfillment of orders for goods or services).

In an embodiment, the token generator 130 is communicatively connected to the server 120 via the network 110. In another embodiment, the token generator 130 may be integrated in the server 120 or otherwise connected to the server 120. According to some embodiments, the server 120 and the token generator 130 are included in a computer platform for managing third party interactions.

The token generator 130 is configured to generate tokens for tracking transactions and redemptions. Each token is a computer readable identifier utilized to represent a series of transactions and redemptions. The tokens may be updated as transactions and redemptions are identified. In an embodiment, each token may be associated with a user of one of the user devices 140 and includes a user identifier representing the user. In a further embodiment, each token includes at least one transaction identifier and at least one redemption identifier. Each transaction or redemption identifier may indicate, but is not limited to, a particular transaction, a particular redemption, a category of transactions, a category of redemptions, a value of a transaction (e.g., a particular value or a range of values), a value of a redemption (e.g., a particular number of points assigned or deducted, or a range of points assigned or deducted), and the like.

Each token may further include metadata. The token metadata may include, but is not limited to, a user identifier for a user, a PAE identifier of a point assigning entity for each transaction initiated by the user, a rewards entity identifier for each redemption initiated by the user, a number of interactions between users, user demographic data (e.g., age, geographic location, friends, contacts, etc.), a current point value, a number of transactions, a number of redemptions, a total value of transactions, a total point value of redemptions, and a combination thereof. Any of the metadata may be further associated with particular types (e.g., donations or purchases) and categories (e.g., donation to the homeless, purchase of video games, purchase of home repair services, etc.) of transactions or redemptions. As an example, the metadata may indicate a total amount of money donated to feeding the homeless and a total amount of money donated to medical research.

In an embodiment, the demographic data may be analyzed to illustrate demographic information related to the transactions, redemptions, or both. Accordingly, in a further embodiment, analytics may be generated based on the tokens. In yet a further embodiment, the analytics may be further based on the metadata. The analytics may include, but are not limited to, a number of users of the user devices 140 initiating particular transactions or redemptions, a number of users of the user devices 140 initiating particular types or categories of transactions or redemptions, total values for particular transactions or redemptions, total values for particular types or categories of transactions or redemptions combinations thereof, and the like. Any of the analytics may be further related to particular demographics as indicated in the demographic information. As a non-limiting example, demographic information related to transactions may indicate the total number or value of donations coming from the United States of America.

In an embodiment, tokens may be classified according to one or more classification rules of the platform used for platform-specific transactions and ranking. The classifications may be, e.g., included in the metadata of each token, visually represented by each token (e.g., by changing a color of a visual representation of the token), or both.

The classification rules may be based on, but not limited to, types of transactions (e.g., donation, purchase), numbers of transactions, values of transactions, categories of transactions (e.g., donation to wildlife conservation funds, purchase of shoes, purchase of flight tickets, etc.), type of transfer (e.g., of currency, of goods, or of services), combinations thereof, and the like. In a further embodiment, the classification rules may indicate a threshold value. As a non-limiting example, a classification “Friend of Animals” may be assigned to a particular token when transaction identifiers or metadata of the token indicate a total amount of money donated to feeding shelter animals that is at least $100. As another non-limiting example, a classification “Sports Fan” may be assigned when a number of purchases of sports-related goods is at least 10. The classifications of tokens may be further utilized for generating analytics related to transactions of the users of the user devices 140.

In an optional embodiment, the server 120 may be configured to automatically provide bonus redemptions or additional points based on the tokens. In a further embodiment, the bonus redemptions or additional points may be provided to a user in response to one or more milestone events related to a token associated with the user. The milestone events may include, but are not limited to, classification of the token into a particular classification, identification of a threshold number or total value of transactions or redemptions, identification of a threshold number or total value of a particular type of transaction, identification of a total number or value of a particular category of transaction or redemption, combinations thereof, and the like. As a non-limiting example, a bonus redemption including a coupon for pet food may be provided to a user when a token of the user is classified into the “Friend of Animals” classification. As another non-limiting example, a bonus redemption including an offer to participate in an exclusive wine tasting event may be provided to a user when a token of the user includes metadata indicating a total amount of money spent on wine purchases over $500.

The server 120 is further configured to utilize an Application Programming Interface (API) for allowing interactions with software of the rewards devices 160. The API allows owners and operators of pre-existing websites such as, but not limited to, Foursquare® and Yelp®, to integrate features of the computing platform into their platforms. Thus, the API may allow rewards entities using the rewards devices 160 to access and modify information such as, but not limited to, whether point-eligible transactions are available; how many point-eligible transactions exist, have been claimed, and are currently available; which friends or contacts of each user have claimed redemptions from the rewards entity; an amount of time since the last redemption was claimed; a current redemption offering list; combinations thereof, and the like. Using features such as the “Product Crosswalk” feature of Factual®, many rewards entities may be matched via their respective counterpart IDs. The API may further allow for integration of features of the computer platform into payment platforms such as, but not limited to, Apple® Wallet.

It should be noted that the API allows for integration with existing systems of rewards entities, thereby allowing for flexible management of rewards programs and, in particular, real-time addition or removal of rewards entities. Further, rewards entities may integrate the computer platform via communication with the server 120, thereby allowing for claiming and validation of redemptions in real-time without requiring predetermined third party physical or network locations for redemption. Accordingly, the disclosed embodiments allow for processing of high volumes of transactions and redemptions in real-time and regardless of physical location.

Further connected to the network 110 are the user devices 140, each user device 140 being configured to execute at least one user application (app) 145. The user app 145 may be, but is not limited to, a web browser, a script, an add-on, a mobile application (“app”), a web application, a virtual application, or any application configured to interact with the server 120. The user device 140 may be, but is not limited to, a personal computer (PC), a personal digital assistant (PDA), a mobile phone, a smart phone, a tablet computer, a laptop, a wearable computing device, and the like.

Through the user app 145, a user may claim transactions and redemptions. In some non-limiting embodiments, the transaction may be performed anonymously or in another's name. The user app 145 may be configured to receive transfers of currency in the form of, e.g., credit card payments, bank transfers, online money transfers such as PayPal®, transfers of virtual currency, combinations thereof, and the like. The user app 145 may be further configured to allow a user of the user device 140 to select and claim redemptions offered via the server 120.

The user app 145 is configured to receive data regarding assignments and deductions of points from the server 120. The points may be assigned and deducted according to a predetermined conversion rate. In an embodiment, the server 120 is configured to cause a percentage of transferred currency to be sent to, e.g., an owner or operator of the computer platform.

A user may also submit a record of time or non-monetary resources donated to a non-profit organization and receive points based on the record. Non-monetary resources may include goods such as, but not limited to, clothing, food, blood, construction materials, research materials, and any other items. In an embodiment, the server 120 may be configured to verify records of time or non-monetary resources. Verifying records of time and non-monetary resources is described in further detail herein below.

In an embodiment, the server 120 may be configured to receive a request to assign points to a recipient user of one of the user devices 140. The request includes at least one identifier (e.g., name, username, email, user ID, etc.) of a user of the user device 140-1 (i.e., the recipient user). The request may be from, for example, a user of the user device 140, a business or non-profit entity using the PAE device 150, or a rewards entity using the rewards entity device 160. If the request is sent by a user of the user device 140-2, the server 120 may be configured to deduct the requested number of assigned points from the total points of the user of the user device 140-2 (i.e., the requesting user). The request may further indicate an additional number of points to assign if particular criteria are met. The server 120 is configured to assign points based on the request. As an example, a non-profit organization using the PAE device 150-1 may request assignment of 50 tokens to a previous donor associated with the user device 140-3 with a promise of 75 more tokens if the donor makes another donation within two weeks of the assignment of the 50 tokens. As another example, the user device 140-2 may send a request to assign 100 points to a point total associated with the user device 140-1. The server 120 deducts 100 points from the point total of the user device 140-2 and assigns 100 points to the point total of the user device 140-1.

The user app 145 may be further configured to cause displays of advertisements via the user device 140. The advertisements may be, for example, of participating business vendors or other rewards entities. The user app 145 is further configured to provide recommended lists of participating non-profit organizations retrieved from the server 120 responsive to keyword searches by the donor.

In an embodiment, the server 120 ranks non-profit organizations associated with any of the PAE devices 150 for display on the user app 145. The ranking may be based on the non-profit organization's popularity, location, age, and the like. Rankings may be further based on recommendations from analytic, review, and data services such as Charity Watchdog®, ProPublica®, Guidestar®, Great Nonprofits®, Charity Navigator®, GiveWell®, and the like. To this end, the server 120 may be further communicatively connected to one or more data sources (not shown) including data related to rankings of non-profit organizations.

Upon authorization by the user, the user app 145 may be configured to access the user's social media accounts using the user's login credentials. Upon a successful login and transaction or redemption, the user app 145 may be configured to automatically create a post highlighting each transaction or redemption claimed by the user. The post may include a referral link, such that the users earns additional points for each other user who claims a transaction through the referral link. If the opportunity to share media (i.e., text, photos, audio, video, and the like) related to an event (e.g., a charitable event) on social networks is available, the server 120 may be configured to assign additional tokens based on sharing of media related to the event.

Further connected to the network 110 are the PAE devices 150 configured to execute at least one PAE application (app) 155. Each of the PAE devices 150 is typically operated by a business or charitable organization offering points in exchange for purchases or donations. The PAE app 155 may be, for example, a web browser, a script, an add-on, a mobile application (“app”), a web application, a virtual application, or any application configured to interact with the server 120. The PAE device 150 may be, but is not limited to, a personal computer (PC), a personal digital assistant (PDA), a mobile phone, a smartphone, a tablet computer, a laptop, a wearable computing device, and the like.

The PAE app 155 is configured to receive inputs related to assignments of points based on transactions from the points assigning entity. Based on the inputs, the PAE app 155 is configured to determine rules for computing points to be assigned based on transaction data. The point computation rules may be different for each points assigning entity using one of the PAE devices 150 and may be based on, but not limited to, types of transactions, categories of transactions, forms of transfers, values of transfers, combinations thereof, and the like. The point computation rules may further include limits on assignments of points including, but not limited to, limiting total numbers of points assigned for a single transaction, limiting the number of transactions for which points will be assigned, and the like.

The PAE app 155 is further configured to receive notifications regarding transactions claimed via the user devices 140 from the server 120.

The PAE app 155 may be further configured to host auctions and raffles for users of the user devices 140. The prizes of the auctions and raffles may be points, goods, services, offers, and the like. Users may pay actual currency or may deduct points to bid on the prize or to receive raffle tickets. Auctions and raffles may be hosted by business vendors (e.g., business vendors using the rewards devices 160 or the PAE devices 150), non-profit organizations (e.g., non-profit organizations using the PAE devices 150), or users (e.g., users of the user devices 140) representing non-profit organizations.

Organizations can manage respective profile pages via the PAE app 155. The profile page may include a brief organization summary, current projects, upcoming events, any recognition the organization has received, current financials, social media pages, and the like. A non-profit organization may further select a breakdown of its needs to be displayed on its profile page to illustrate potential donations accepted by the organization. When a donor donates volunteered time or non-monetary goods, the donor “promises” an amount of time or goods and is rewarded by the non-profit organization after the organization validates the time or goods through a code, such as, but limited to, a QR code, a bar code, an email code, a numerical code, and the like.

Each point assigning entity's profile page may also include recommendations of other point assigning entities, transactions, or both. For example, a charity may recommend other charities that it recommends donating to. As another example, a sporting goods company may recommend athletic products to purchase. The profile page may also include recommendations of rewards entities offering redemptions for points.

Each organization using the computer platform may be provided with a short-code link that the organization can copy and embed on the organization's own website or social media profile which indicates that the organization participates in the disclosed computing platform. Visitors to the website or social media profile of the organization can click the link to be taken to the organization's profile page on the computing platform.

The PAE app 155 may be further configured to send out a “call to action” to the user devices 140. The “call to action” is typically a message asking users to aid a particular event, team, or organization. Users may opt out of receiving “call to action” messages via the user app 145.

Further connected to the network 110 are the rewards devices 160 configured to execute at least one rewards application (app) 165. The rewards app 165 may be, for example, a web browser, a script, an add-on, a mobile application (“app”), a web application, a virtual application, or any application programmed to interact with the server 120. The rewards entity device 160 may be, but is not limited to, a personal computer (PC), a personal digital assistant (PDA), a mobile phone, a smart phone, a tablet computer, a laptop, a wearable computing device, and the like.

Rewards entities using the rewards devices 160 offer rewards in exchange for claiming redemptions by deducting points. The rewards entities may include, but are not limited to, “brick and mortar” stores; mobile services such as home services, delivery, and the like; online retailers; and any other entity offering rewards in exchange for redemptions of points. Example rewards include goods, services, offers, coupons, combinations thereof, and the like. validation is performed online for online retailers while mobile services utilize the rewards entity device 160 and, specifically, the rewards app 165, at the location for redemption. In an embodiment, redemption includes proximity redemption where the user device 140 and the rewards entity device 160 communicate (e.g., over the network 110) for redemption.

In an example embodiment, each rewards entity associated with a rewards app 165 is assigned an automatically generated, random code. The random codes may be assigned at, for example, the end of each business day or other regular intervals of time. A user wishing to claim a reward can read the details about the reward on the vendor's profile page in the computing platform via the user app 145. When the user confirms that he or she wishes to redeem the reward, the assigned code for the respective rewards entity may be revealed on the user app 145. The rewards entity may validate that the code on the user app 145 matches the code on the rewards app 165 and instruct the donor to hit a “Claim” button or link on the user app 145 to transfer the amount of tokens required to redeem the offer. This prevents donors from claiming offers falsely without token deduction.

Users of the user devices 140 may also redeem a reward via proximity-based means. For example, if a user checks into a participating vendor on a check-in service such as Foursquare®, Yelp®, Swarm®, and the like, the offer is automatically unlocked. The check-in service may be integrated into the computer platform.

The rewards app 165 is further configured to receive input related to point values for each available redemption offered by a rewards entity. Rewards entities may create rewards that are locked until a user has met one or more locked reward criteria. The locked reward criteria may be particular to specific redemptions or groups of redemptions, and may include, but is not limited to, claiming a previous redemption at least a predetermined number of times. As an example, an offer to purchase a particular entrée may be locked until the user has claimed an offer to purchase a particular appetizer 3 times at the same restaurant or chain.

The rewards app 165 may be further configured to receive input for setting the option of allowing users to reserve a reward if the quantity of the reward is limited. Reservation of rewards may be, e.g., free so long as the user qualifies for the reward (i.e., has met any criteria and has sufficient points), or may require deduction of points. Additionally, the business vendor can choose to have a predetermined point deduction if the user does not claim the redemption after reserving.

The rewards app 165 may be further configured to receive payment information and to send such payment information to the server 120 for advertisements in user apps 145, preferred rankings in search results, or other features provided by the computer platform. To this end, the rewards app 165 may be further configured to receive advertising content and to send such advertising content to the server 120.

It should be noted that either or both the server 120 and the token generator 130 typically comprises a processing system (not shown) and a memory (not shown). The processing system may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit may be coupled to the memory. In an embodiment, the memory contains instructions that when executed by the processing unit results in the performance of the methods and processes described herein below. Specifically, the processing unit may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing unit to perform the various functions described herein.

It should also be noted that the server 120 is described as communicatively connected to the token generator 130 over the network 110 merely for simplicity purposes and without limitation on the disclosed embodiments. The server 120 and the token generator 130 may be directly connected without departing from the scope of the disclosure. In a further embodiment, the server 120 may include the token generator 130 or may be otherwise integrated with the token generator 130.

It should be further noted that the embodiments described herein with respect to FIG. 1 are discussed based on a user app 145, a PAE app 155, and a rewards app 165 merely for simplicity purposes and without limitation on the disclosed embodiments. Any of the devices 140, 150, 160, and the apps 145, 155, and 165 may be the same device or app configured to operate based on functions required for the entity currently using the app. For example, an app may allow a user to select whether the user is acting as a customer or donor (i.e., the user is acting as a user of the user device 140), as a seller or non-profit organization (i.e., the user is acting as a point assigning entity using the PAE device 150), or as a third party providing rewards (i.e., the user is acting as a rewards entity using the rewards entity device 160).

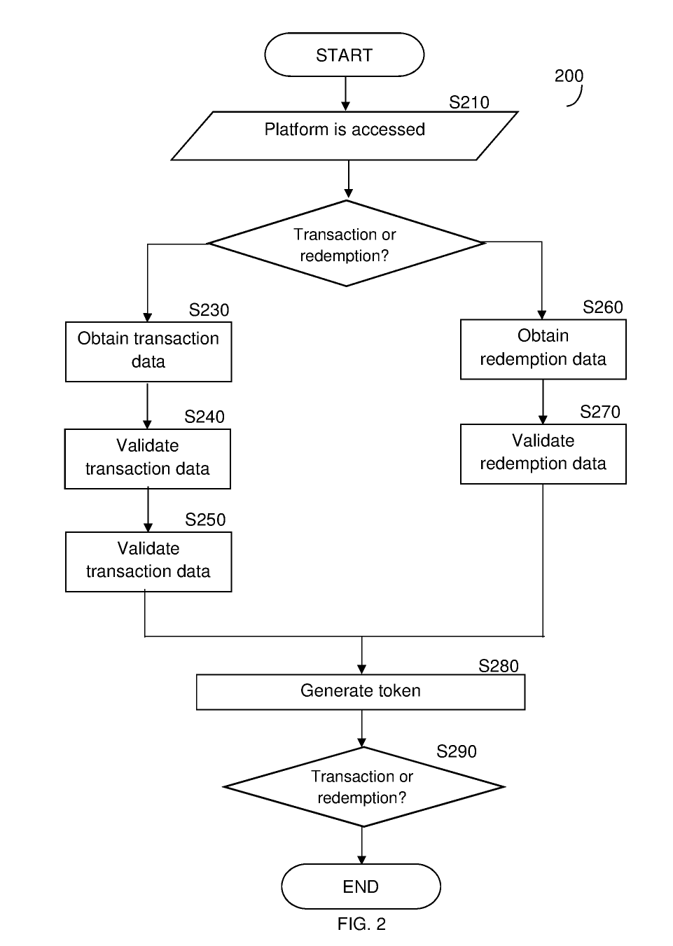

FIG. 2 is an example flowchart 200 illustrating a method of managing points-based transactions and redemptions according to an embodiment. In an embodiment, the method is performed by the server 120.

At S210, a computing platform is accessed by a user (e.g., via the user device 140). In an embodiment, the access may occur via execution of the user app 145.

At S220, it is checked whether a transaction or redemption has been claimed by the user. If a transaction has been claimed, execution continues with S230; if a redemption has been claimed, execution continues with S260.

At S230, upon identifying that a transaction has been claimed, transaction data is obtained. The transaction data may include, but is not limited to, a PAE identifier of the entity assigning points during the transaction, a transaction identifier associated with the transaction, a type of the transaction (e.g., a purchase or a donation), a category of the transaction, a form of transfer (e.g., transfer of currency, transfer of goods, or time spent performing services), a category of transfer (e.g., donation of money to religious organization, time spent volunteering at animal shelter, purchase of shoes, purchase of vehicle, etc.) a value of the transfer (e.g., an amount of currency, an amount of each good transferred, an amount of time, etc.), payment information (e.g., credit card number, bank account number, an account identifier, etc.), combinations thereof, and the like. The transaction identifier may be unique to a particular transaction or kind of transaction (e.g., donation to a particular fundraiser or purchase of a particular type of toy).

At optional S240, the transaction data may be validated. In an embodiment, S240 may include automatically verifying a transfer of currency. For example, S240 may include querying a server of a bank associated with the point assigning entity identified by the PAE identifier to determine whether the value of the transfer was added to the point assigning entity's funds. In another embodiment, S240 may include prompting the point assigning entity via an application on a PAE device (e.g., the PAE app 150-1) to confirm receipt of currency, goods, or services.

At S250, a point value to be assigned to the user is determined based on the transaction data and execution continues with S280. In an embodiment, the point value may be determined based on one or more predetermined points computation rules as set by the point assigning entity. As a non-limiting example, 100 points may be assigned for every $1 US donated. As another example, 50 points may be assigned for each hour of time spent volunteering. As yet another example, 50 points may be assigned for each hour of time spent volunteering to clean up the ocean, while 25 points may be assigned for each hour of time spent volunteering planting trees).

At S260, upon determining that a redemption has been claimed, redemption data is obtained. The redemption data may include, but is not limited to, a rewards entity identifier, a reward identifier, a type of reward (e.g., currency, goods, services, offers, coupons, a bid in an auction, raffle tickets, a gift of points to another user, etc.), a point value to be deducted, a combination thereof, and the like.

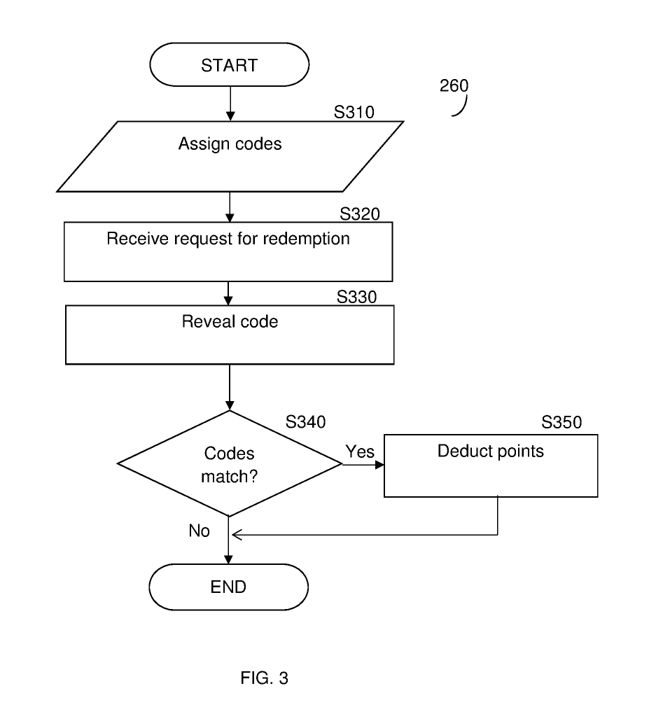

At optional S270, the redemption may be validated. Validating redemptions is described further herein below with respect to FIG. 3.

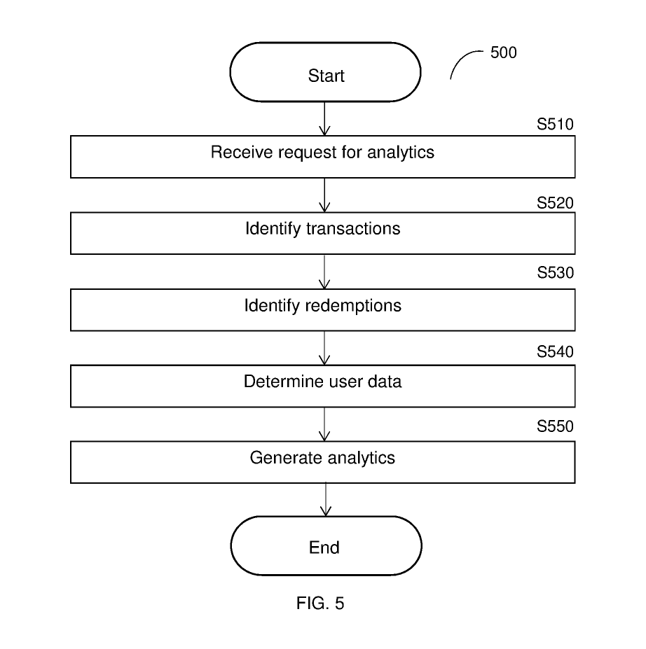

At S280, a token is generated. In an embodiment, S280 further includes adding or deducting points from a point total of a user associated with the token. In an embodiment, the generated token includes a user identifier of the user, at least one transaction identifier, at least one redemption identifier, or a combination thereof. In an embodiment, the generated token includes the PAE identifier, transaction identifiers, and redemption identifiers of a previously generated token associated with the user. Accordingly, the token may indicate a series of transactions and redemptions claimed by the user. Such a series of transactions and redemptions may be analyzed to generate analytics as described further herein below with respect to FIG. 5.

In a further embodiment, the token may include metadata as described further herein above. In yet a further embodiment, the metadata may include a point value, wherein the point value is further based on the determined point value to be assigned and a point value indicated by metadata of the previously generated token. In an embodiment, S260 may further include sending a notification to an application (e.g., the application 145-1) installed on a device accessed by the user.

At S290, it is determined whether additional transactions or redemptions have been claimed and, if so, execution continues with S220; otherwise, execution terminates.

FIG. 3 is an example flowchart 260 illustrating a method of validating redemptions according to an embodiment.

At S310, a code is assigned to each of at least one rewards entity offering rewards based on redemptions. A user wishing to claim a redemption can read the details about the redemption on the rewards entity's profile page via a user application of a user device utilized by the user. The code may include, but is not limited to, one or more characters (e.g., alphabetical, numerical, or other characters), a QR code, a barcode, and any other information that is unique a particular rewards entity at any given time.

At S320, a request is received from a redeeming user to redeem at least one reward in exchange for a number of points. In an embodiment, the request may be received from a user app installed on a user device utilized by the redeeming user. The request may indicate each reward to be redeemed, the rewards entity offering each reward, or both. Each reward may be for, but is not limited to, a discount of goods or services from the rewards entity, a free good or service from the rewards entity, or other rewards as described further herein above.

At S330, the generated code for the rewards entity is revealed via the user app. At S340, it is checked whether the code revealed via the user app matches the code assigned to the rewards entity and, if so, execution continues with S350; otherwise, execution terminates. In an embodiment, the matching occurs via visual confirmation. In an embodiment, the donor enters a code into the vendor app. At S350, upon validating the redemption, a number of points associated with the redemption is deducted from total point value of the redeeming user. One skilled in the art will appreciate this method prevents users from claiming offers falsely without token deduction.

It should be noted that the embodiment described herein above with respect to FIG. 3 is a non-limiting example of validating redemptions. Other methods for validating redemptions may be utilized without departing from the scope of the disclosure.

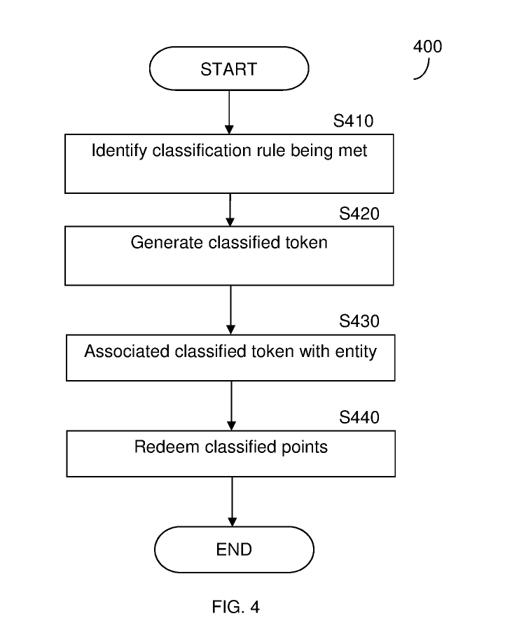

FIG. 4 is an example flowchart 400 illustrating a method for classifying tokens according to an embodiment. At S410, it is determined that at least one classification rule has been met. In an embodiment, the determination that classification rules have been met is based on a token associated with an entity. In a further embodiment, the classification rules may be further based on one or more milestone events such as, but not limited to, frequency of donation, frequency of event participation, integration of the platform into a non-profit organization or vendor website, and other metrics of platform usage. At S420, a classified token is generated. In an embodiment, classified token generation is initiated at the request of an administrator of a computing platform. The classified token may be generated based on the token associated with the user. The classified tokens may be visually differentiated via color, via an ID associated with the tokens, via metadata, or a combination thereof. The classified token may further indicate a number of points of the entity that are associated with the classification of the classified token. Any or all of the points associated with the classified token may be classified. Such classified points may be utilized for particular redemptions.

At S430, the classified token is associated with the entity. The entity may be, but is not limited to, a user (e.g., a donor or customer), a point assigning entity (e.g., a non-profit organization or business), or a rewards entity. In an embodiment, classified tokens are distributed for reaching certain milestones. At S440, points indicated by the classified token are redeemed by the user. In an embodiment, the points may be redeemed for any of goods, services, currency, offers, coupons, and the like, with classified points being redeemable for selected goods, services, currency, offers, coupons, and the like.

FIG. 5 is an example flowchart 500 illustrating a method for generating analytics based on interactions among at least one device of a first plurality of device, at least one device of a second plurality of devices, and at least one entity of a third plurality of devices according to an embodiment. In an embodiment, the method may be performed by a server (e.g., the server 120). In an example embodiment, the first plurality of devices may be the user devices 140, the second plurality of devices may be the PAE devices 150, and the third plurality of devices may be the rewards entity devices 160.

At S510, a request to generate analytics is received. The request may include, but is not limited to, an identifier associated with each entity for which analytics should be generated. At S520, at least one transaction is identified. Each transaction is between one of the first plurality of devices and one of the second plurality of devices. In an embodiment, identifying the at least one transaction may include analyzing a plurality of tokens generated based on transactions and redemptions as described herein above with respect to FIG. 2. The identified transactions may be transactions associated with the entities for which analytics should be generated. In an embodiment, S520 further includes identifying transaction data for each transaction. The transaction data may be indicated by metadata of the analyzed tokens.

At S530, at least one redemption is identified. Each redemption is between one of the first plurality of devices and one of the second plurality of devices. In an embodiment, identification of the at least one redemption may be based on the analyzed plurality of tokens. The identified redemptions may be redemptions associated with the entities for which analytics should be generated. In an embodiment, S530 further includes identifying redemption data for each redemption. The redemption data may be indicated by metadata of the analyzed tokens. At optional S540, user data related to each token associated with the at least one transaction or with the at least one redemption may be determined. The token data may include, but is not limited to, a user associated with each token, demographic information associated with each token, a combination thereof, and the like.

At S550, based on the transaction data and the redemption data, at least one analytic is generated. In an embodiment, the analytics are generated further based on the token data. The analytics may include, but are not limited to, a number of devices of the first plurality of devices claiming a particular transaction or category of transaction; a number of devices of the first plurality of devices claiming a particular redemption or category of redemption; correlations between particular transactions or categories of transactions and particular redemptions or categories of redemptions; a number of claimed transactions associated with one of the second plurality of devices; a number of claimed redemptions associated with one of the third plurality of devices; a number of tokens having a particular classification; a total point value redeemed for a particular redemption, for a category of redemption, or for one of the third plurality of devices; combinations thereof; and the like.

As a non-limiting example, a request to generate analytics for a group of donors donating to charitable causes is identified. Donations by the donors are identified as transactions along with transaction data for each of the identified transactions. The transaction data indicates 10,000 donations made to hurricane relief efforts. Redemptions of points claimed by the donors are identified along with redemption data for each of the identified redemptions. The redemption data indicates 500 redemptions of points in exchange for a reservation at a particular restaurant and 100 redemptions of points in exchange for a shirt saying “I helped with hurricane relief.” Based on the transaction and redemption data, analytics indicating the numbers of each transaction and redemption as well as the correlations between the hurricane relief donations and each of the restaurant reservation and the shirt are generated.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure. Furthermore, the foregoing detailed description has set forth a few of the many forms that the disclosed embodiments can take. It is intended that the foregoing detailed description be understood as an illustration of selected forms that the disclosure can take and not as a limitation to the definition of the disclosed embodiments.

What is claimed is:

1. A method for managing third party interactions, comprising:
identifying at least one transaction, wherein each transaction is between a first device and one of a plurality of second devices;
obtaining transaction data of each identified transaction, wherein the transaction data includes a value and a transaction identifier of each transaction;
identifying at least one redemption, wherein each redemption is between the first device and one of a plurality of third devices;
obtaining redemption data of each identified redemption, wherein the redemption data includes a point value deduction and a redemption identifier associated with each redemption;
determining, based on the transaction data and the redemption data, a total point value associated with the first device; and
generating a computer readable token for the first device, the token including each transaction identifier and each redemption identifier, the token further including metadata, wherein the metadata includes the determined total point value.

2. The method of claim 1, further comprising:
identifying at least one subsequent interaction, wherein each subsequent interaction is any of: a subsequent transaction, and a subsequent redemption;
obtaining data of the at least one subsequent interaction, wherein the subsequent interaction data includes at least one of: transaction data of each subsequent transaction and redemption data of each subsequent redemption; and
generating, based on the token and the obtained subsequent interaction data, a new token.

3. The method of claim 1, further comprising:
determining, based on at least one classification rule, whether the generated token should be classified; and
upon determining that the generated token should be classified, generating a classified token based on the token.

4. The method of claim 1, further comprising:
computing, for each transaction, an assignment point value, wherein the computation is based on the value of the transaction.

5. The method of claim 4, wherein the computation is further based on at least one of: a type of the transaction, a category of the transaction, and a transfer associated with the transaction.

6. The method of claim 5, wherein the transfer is of at least one of: a transfer of currency, a transfer of goods, a provision of services, and a transfer of points.

7. The method of claim 1, wherein the metadata includes demographic data associated with a user of the first device.

8. The method of claim 7, further comprising:
generating, based on the generated token and at least one other token, at least one analytic.

9. The method of claim 8, wherein the at least one analytic is generated further based on the transaction identifier of each identified transaction and the redemption identifier of each identified redemption.

10. A non-transitory computer readable medium having stored thereon instructions for causing one or more processing units to:
identify at least one transaction, wherein each transaction is between a first device and one of a plurality of second devices;
obtain transaction data of each identified transaction, wherein the transaction data includes a value and a transaction identifier of each transaction;
identify at least one redemption, wherein each redemption is between the first device and one of a plurality of third devices;
obtain redemption data of each identified redemption, wherein the redemption data includes a point value deduction and a redemption identifier associated with each redemption;
determine, based on the transaction data and the redemption data, a total point value associated with the first device; and
generate a computer readable token for the first device, the token including each transaction identifier and each redemption identifier, the token further including metadata, wherein the metadata includes the determined total point value.

11. A system for managing third party interactions, comprising:
a token generator configured to generate a computer readable token including identifiers of interactions;
a processing unit; and
a memory, the memory containing instructions that, when executed by the processing unit, configure the system to:
identify at least one transaction, wherein each transaction is between a first device and one of a plurality of second devices;
obtain transaction data of each identified transaction, wherein the transaction data includes a value and a transaction identifier of each transaction;
identify at least one redemption, wherein each redemption is between the first device and one of a plurality of third devices;
obtain redemption data of each identified redemption, wherein the redemption data includes a point value deduction and a redemption identifier associated with each redemption;
determine, based on the transaction data and the redemption data, a total point value associated with the first device; and
generate, by the token generator, the token for the first device, the token including each transaction identifier and each redemption identifier, the token further including metadata, wherein the metadata includes the determined total point value.

12. The system of claim 11, wherein the system is further configured to:
identify at least one subsequent interaction, wherein each subsequent interaction is any of: a subsequent transaction, and a subsequent redemption;
obtain data of the at least one subsequent interaction, wherein the subsequent interaction data includes at least one of: transaction data of each subsequent transaction and redemption data of each subsequent redemption; and
generate, based on the token and the obtained subsequent interaction data, a new token.

13. The system of claim 11, wherein the system is further configured to:
determine, based on at least one classification rule, whether the generated token should be classified; and
upon determining that the generated token should be classified, generate a classified token based on the token.

14. The system of claim 11, wherein the system is further configured to:
compute, for each transaction, an assignment point value, wherein the computation is based on the value of the transaction.

15. The system of claim 14, wherein the computation is further based on at least one of: a type of the transaction, a category of the transaction, and a transfer associated with the transaction.

16. The system of claim 15, wherein the transfer is of at least one of: a transfer of currency, a transfer of goods, a provision of services, and a transfer of points.

17. The system of claim 11, wherein the metadata includes demographic data associated with a user of the first device.

18. The system of claim 17, wherein the system is further configured to:
generate, based on the generated token and at least one other token, at least one analytic.

19. The system of claim 18, wherein the at least one analytic is generated further based on the transaction identifier of each identified transaction and the redemption identifier of each identified redemption.
